(19) United States
(12) Patent Application Publication
(10) Pub. No.: US 2020/0403922 A1
(43) Pub. Date: Dec. 24, 2020

(54) LOAD BALANCING OF L2VPN TRAFFIC OVER MULTIPLE IPSEC VPN TUNNELS

(71) Applicant: VMware, Inc., Palo Alto, CA (US)

(72) Inventors: Jia Yu, San Jose, CA (US); Yong Wang, San Jose, CA (US); Xinhua Hong, Campbell, CA (US); Fang Peng, Saratoga, CA (US); Zhifeng Xia, San Jose, CA (US)

(73) Assignee: VMware, Inc., Palo Alto, CA (US)

(21) Appl. No.: 16/450,026

(22) Filed: Jun. 24, 2019

(51) Int. Cl. H04L 12/803; H04L 12/46; H04L 29/06; H04L 12/713

(52) U.S. Cl. CPC H04L 47/125; H04L 12/4641; H04L 45/586; H04L 12/4633; H04L 69/22

(57) ABSTRACT

In an embodiment, a computer-implemented method provides mechanisms for load balancing of L2VPN traffic over multiple IPsec VPN tunnels. In an embodiment, a method comprises: performing, by a gateway, a lookup of available virtual tunnel interfaces (“VTIs”) implemented in the gateway to determine a plurality of VTIs; generating a hash value from contents of one or more inner headers of the packet; based on the hash value, determining a VTI device identifier; wherein the VTI device identifier uniquely identifies a particular VTI from the plurality of VTIs; and relaying the packet on a gateway output port that is associated with the particular VTI to allow forwarding of the packet via a particular IPsec VPN tunnel of a plurality of IPsec VPN tunnels.

### BACKGROUND

A Layer 2 Virtual Private Network (“L2VPN”) is a means for stretching logical networks across geographical location or sites. The L2VPN may be managed by, for example, a software defined networking (“SDN”) manager implemented on premises and off premises in the corresponding SDN edge gateways. The L2VPN may be implemented using L2VPN tunnels established between two edge gateways.

One type of L2VPNs implements the Generic Routing Encapsulation (“GRE”) over Internet Protocol security (“IPsec”) tunnels. A GRE tunnel and an IPsec tunnel typically correspond to each other and are 1-to-1 bound. The information that specifies the corresponding virtual tunnel interfaces (“VTIs”) and how a GRE remote IP address can be reached from the VTIs is provided to a service router to allow routing of the L2VPN packets. The packets transmitted through the VTI devices are encrypted and sent through the corresponding IPsec VPN tunnel. However, these implementations have some limitations. For example, the L2VPN tunnel is usually limited by the maximum throughput of the corresponding IPsec tunnel. Hence, even if a cross-cloud configuration maintains multiple communications links between the sites, the available bandwidth of the links is underutilized because the L2VPN traffic is using only one IPsec tunnel and one cross-site link, not all available links.

Current L2VPN implementations also suffer from performance issues. This may be caused by the fact that L2VPN is configured to use one VTI interface. A gateway in this context is a logical communications device that provides connectivity from one datacenter to another datacenter. A datacenter is a group of networked computer servers used to store, process and/or distribute large amounts of data. Since virtual machines (“VMs”) implemented in datacenters may generate heavy L2 traffic to remote sites, the traffic from the VMs is often stalled because the gateway directs all the L2VPN packets to the same VPN tunnel.

Another issue is a time-consuming processing of the L2VPN packets. The processing may include detecting an L2 packet that goes through an L2VPN tunnel, generating a GRE IP header for the packet, encapsulating the L2 packet with the GRE IP header and the GRE header, and encapsulating the packet with outer headers. Since the packet processing is time consuming and needs to be performed for each packet before the packet may be communicated via a VPN, and since the gateway directs all the L2VPN packets to the same VPN tunnel, handling the L2 packets via the VPN may cause bottlenecks.

Other problems include CPU balancing issues. When a network interface card (“NIC”) on a receiving gateway receives an encapsulated packet, it invokes the Receive Side Scaling (“RSS”) functionalities to compute a hash value from the packet's outer headers (L3-L4 headers) and uses the hash value to determine an Rx queue and to select a CPU for processing the packet. Different flows carried through the same VPN tunnel have the same signature for the purpose of RSS hashing. Thus, a load balancer implemented on the receiving gateway selects the same CPU for processing all L2VPN packets carried through the same VPN tunnel. Selecting the same CPU for processing all L2VPN traffic may cause overloading the selected CPU, and under-utilizing the remaining CPUs implemented on the gateway.

Other problems include a lack of redundancy in L2VPN tunnels. Since in two-sites configurations the conventional L2VPN gateways use only one VPN tunnel, failure of that VPN tunnel may stall the L2VPN communications. If that tunnel becomes nonoperational, the VMs in the stretched L2 network cannot communication with each other.

### SUMMARY

In an embodiment, mechanisms for load-balancing L2VPN traffic over multiple IPsec VPN tunnels are described. The mechanisms allow to load balance L2VPN traffic communicated between datacenters. In this approach, a datacenter gateway is configured with a plurality of VTI devices, and each VTI device is backed up by a separate IPsec VPN tunnel of a plurality of VPN tunnels.

In an embodiment, a gateway uses a plurality of VTI devices to direct L2VPN traffic to different IPsec VPN tunnels, and not just to one IPsec VPN tunnel as in conventional networks. Because the gateway uses different IPsec VPN tunnels to communicate the L2VPN traffic, the presented approach solves most of the bandwidth and performance issues that frequently occur in the conventional L2VPN networks.

To enable the approach, routes for communicating L2VPN packets via multiple IPsec VPN tunnels may be added to forwarding information bases (“FIBs”) of service routers. The route information stored in a FIB is used by a service router to determine a next hop for a packet to forward the packet toward a remote GRE IP address.

Selection of a VTI device, from a plurality of VTI devices, for a packet is performed based on a hash value computed from contents of inner headers of the packet, and not based on contents of, for example, GRE IP headers of the packet as in conventional L2VPNs.

In an embodiment, a hash value is computed based on contents of an inner IP header of a packet. For example, the hash value may be computed based on the 5-tuple included in the inner L3/L4 header. The 5-tuple may include a source IP address, a destination IP address, a source port identifier, a destination port identifier, and a protocol identifier. The 5-tuple may be extracted from the packet when the packet is detected by an L2 enabled device, stored in memory, and made available when the hash value needs to be determined. The hash value may be determined by performing an XOR-based-hashing. i.e., by applying an XOR logical operator to the 5-tuple to derive the hash value. The hash value may be accessible via a packet handle.

In an embodiment, a hash value is computed based on contents of both an IP header and a TCP/UDP header of a packets.

Selecting a VTI device may utilize an equal-cost multi-path routing (“ECMP”) approach. ECMP is a routing strategy for determining a next-hop for forwarding a packet based on selecting a particular path from multiple paths. ECMP may select the particular path based on certain criteria such as cost, reliability and/or latency. In an embodiment, the ECMP approach is used to determine a next-hop for L2VPN packets based on hash values computed for the packets. The hash values may be read using, for example, a packet handle. The hash values are used to obtain the index to a table of VTI devices. Hash value itself is never stashed.

Hash values computed using the presented approach are often different for different flows. Therefore, a gateway most likely selects for different flows different VTIs from a plurality of VTIs configured on the gateway. Subsequently, the gateway most likely selects for different flows different IPsec VPN tunnels from multiple VPN tunnels.

A hash value for a packet may be determined by a load balancer or a datapath process implemented in a gateway of a datacenter. The load balancer or the datapath usually determines different hashes for different flows. This approach is referred to as a flow-based load balancing.

A hash value for a packet may be determined by a logical switch. The logical switch may determine a hash value for the packet by performing a hash operation on contents of an inner VLAN header of the packet. This approach is referred to as a logical switch level local balancing.

### BRIEF DESCRIPTION OF THE DRAWINGS

In the drawings:

FIG. 1 is a block diagram depicting an example physical implementation view of an example logical network environment for realizing mechanisms for load balancing of L2VPN traffic over multiple IPsec VPN tunnels.

FIG. 2A is a block diagram depicting an example multiple IPsec VPN tunnels established between two gateways.

FIG. 2B is an example of a packet.

FIG. 3 is a flow chart for selecting, by a packet sending gateway, a virtual tunnel interface and selecting an IPsec VPN tunnel.

FIG. 4 is an example flow chart for selecting, by a packet receiving gateway, a CPU to process an L2VPN packet.

### DETAILED DESCRIPTION

In the following description, for the purposes of explanation, numerous specific details are set forth in order to provide a thorough understanding of the method described herein. It will be apparent, however, that the present approach may be practiced without these specific details. In some instances, well-known structures and devices are shown in a block diagram form to avoid unnecessarily obscuring the present approach.

1. Example Physical Implementations

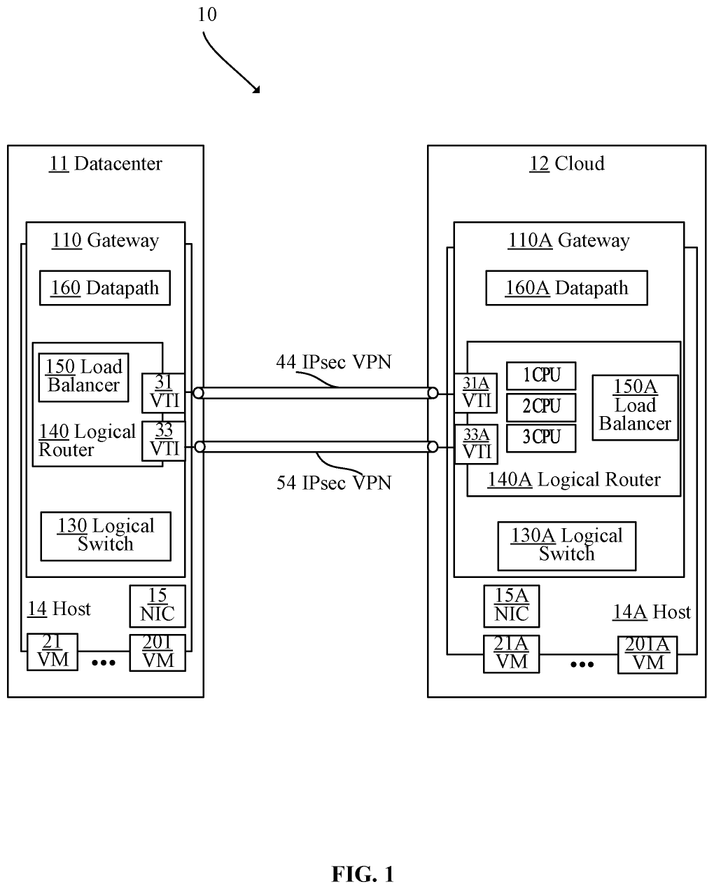

FIG. 1 is a block diagram depicting an example physical implementation view of an example logical network environment for realizing mechanisms for load balancing of L2VPN traffic over multiple IPsec VPN tunnels. In the depicted example, environment 10 includes a datacenter 11, a cloud environment 12, and a plurality of IPsec VPN tunnels 44, 54 established between datacenter 11 and cloud 12. Environment 10 also includes a physical network (not shown) along with additional elements such as routers and switches.

Datacenter 11 may include one or more gateways 110 and one or more hosts 14-14A. Gateway 110 may be configured to execute a datapath process 160, a load balancer process 150, a logical router 140, and one or more logical switches 130. Host 14 may support one or more VMs 21, 201.

Cloud 12 may include one or more gateways 110A and one or more hosts 14-14A. Gateway 110A may be configured to execute a datapath process 160A, a load balancer process 150A, a logical router 140A, and one or more logical switches 130A. Host 14A may support one or more VMs 21A, 201A.

Hosts 14-14A are computer devices configured to implement VMs, such as VMs 21-201 and 21A-201A, gateways 110-110A, logical routers 140-140A, logical switches 130-130A, and the like. The hosts may be referred to as computing devices, host computers, host devices, physical servers, server systems, or physical machines. The hosts may include hardware components such as commodity hardware computing platforms including computing processors, memory units, physical network interface cards (“NICs”) 15-15A, and storage devices (not shown).

VMs 21-201 and 21A-201A are examples of virtualized computing instances or workloads. A virtualized computing instance may include an addressable data compute node or an isolated user space instance, often referred to as a name space container.

1.1. Gateways

Gateways 110-110A comprise software that may be installed in a virtual machine or on a physical server. Gateways 110-110A may be implemented as edge gateways and may be configured to provide network services such as DHCP, firewall, NAT, static routing, VPN, and load balancing. Gateways 110-110A may provide network edge security and gateway services to VMs 21-201 and 21A-201A. Gateways 110-110A may be installed either as logical, distributed routers or as services gateways. Gateways 110-110A may be configured to connect isolated sub networks to shared networks.

In an embodiment, gateways 110-110A are configured to execute datapath processes 160-160A and load balancer processes 150-150A. Datapaths 160-160A may be implemented as network stacks that comprise collections of functional units configured to perform data processing operations and arithmetic operations on packets. Load balancers processes 150-150A may be implemented in logical devices configured to improve the distribution of workloads and network traffic across communications tunnels and multiple computing resources.

1.2. VPN Tunnels

In an embodiment, gateway 110 supports a plurality of site-to-site IPsec VPN tunnels that are established between datacenter 11 and other datacenters. For example, gateway 110 may support a plurality of site-to-site IPsec VPN tunnels 44-54 established between datacenter 11 and cloud 12. The IPSec VPN tunnels may use the IPsec to secure the IP packets communicated within IP communications sessions and via tunnels 44-54. From the perspective of VPN users of datacenter 11, gateway 110 extends a private network of datacenter 11 across a public network of cloud 12 and enables the VPN users of the private networks to send and receive data across the public network as if the resources of cloud 12 were connected to the private network of datacenter 11.

1.3. Virtual Tunnel Interfaces

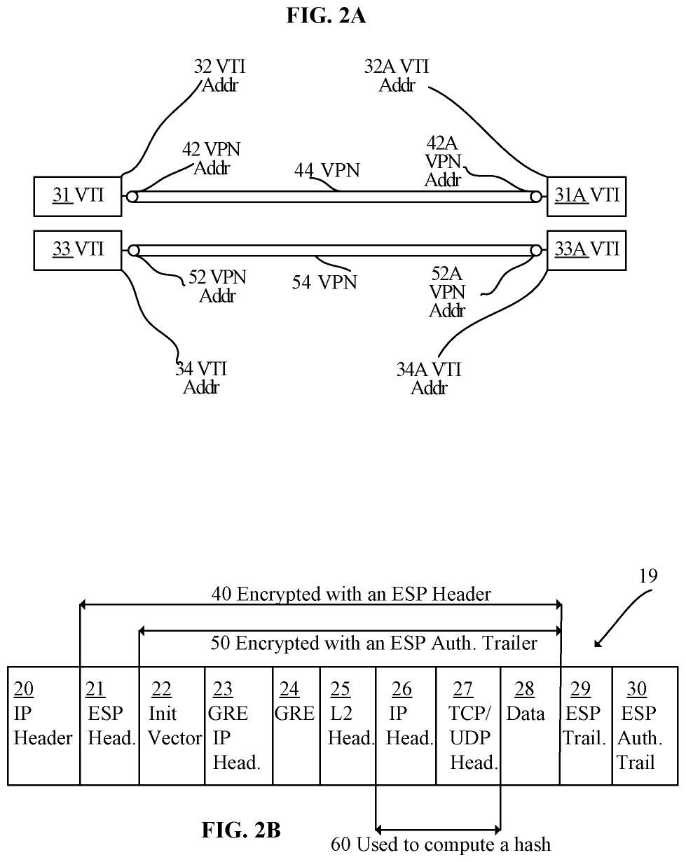

FIG. 2A is a block diagram depicting an example multiple IPsec VPN tunnels established between two gateways. In the depicted example, VPN tunnels 44-54 are established between gateways 110-110A, as shown in FIG. 1.

IPsec VPN tunnel 44 has one endpoint that is configured with an underlay VPN address 42 on gateway 110 and another endpoint that is configured with an underlay VPN address 42A on gateway 110A. Underlay VPN address 42 is reachable within datacenter 11, while underlay VPN address 42A is reachable within cloud 12. VTI 31 has an VTI address 32, while VTI 31A has an address VTI 32A.

IPsec VPN tunnel 54 has one endpoint that is configured with an underlay VPN address 52 on gateway 110 and another endpoint that is configured with an underlay VPN address 52A configured on gateway 110A. Underlay VPN address 52 is reachable within datacenter 11, while underlay VPN address 52A is reachable within cloud 12. VTI 33 has an VTI address 34, while VTI 33A has an address VTI 34A.

From the perspective of logical routers 140-140A, logical routers 140-104A relay VPN packets onto individual VTIs and, subsequently, to either IPsec VPN tunnel 44 or IPsec VPN tunnel 54.

In an embodiment, one BGP session is created for each VTI interface and the routes to the subnets. In the depicted example, the VPN sessions include a VPN session for VPN tunnel 44 and a VPN session for VPN tunnel 54. The endpoints of VPN tunnel 44 have underlay VPN addresses 42 and 42A, while the endpoints of VPN tunnel 54 have underlay VPN addresses 52 and 52A.

On a packet sending side, when a gateway, such as gateway 110, receives a packet from a VM and the packet is in the L2 stretched network, then gateway 110 encapsulates the original packet with a GRE header and relays the packet to one of a plurality of VTIs. Selecting the VTI is based on a hash value computed based on the inner header of the packet, and since the hash values may be different for different flows, the present approach allows to load balance the VPN traffic over multiple IPsec VPN tunnel for different flows.

On a packet receiving side, a gateway, such as gateway 110A, receives a VPN packet and determines a CPU stack on which to place the packet to load balance the L2VPN traffic on the receiver site.

In an embodiment, upon detecting a packet on a particular VTI, a NIC 15 implemented in gateway 110A, based on the hash puts the packet into a particular Rx queue. A particular CPU will process the packet in the particular Rx queue.

2. Load Balancing of L2VPN Traffic

2.1. Selecting an IPsec VPN Tunnel from Multiple Tunnels

In an embodiment, upon receiving a packet, a gateway employs the ECMP approach to select a VTI, from a plurality of VTIs implemented on the gateway, and relays the packet onto the selected VTI to communicate the packet via one of a plurality of IPsec VPN tunnels.

In an embodiment, the ECMP approach is employed to determine a hash value for a packet based on contents of inner headers of the packet, not based on contents of outer headers as in conventional approaches. Had the ECMP used the addresses from an outer header, such L3 IP header, the hash values for all flows would be the same, and thus the same VTI and the same IPsec VPN tunnel would have been selected for all flows. But, since the addresses in the inner header(s) may be different for different flows, the hash values computed from the inner headers of packets for different flows may be different. Thus, different VTIs may be selected for different flows.

The contents of inner headers of a packet may be stored in memory by an L2 enabled device before the packet is encrypted and encapsulated. In an embodiment, an offset value with respect to the location of the inner headers in a non-encrypted and encapsulated packet is obtained and used to access the contents of the inner headers when the hash value for the packet needs to be computed.

FIG. 2B is an example of a packet. In the depicted example, a packet 19 includes a portion 60, which includes an inner IP header 26 and an inner TCP/UDP header 27. In addition to headers 26-27, packet 19 includes an outer IP header 20, an ESP header 21, an initialization vector 22, a GRE IP header 23, a GRE header 24, a L2 header 25, a data field 28, an ESP trailer 29, and ESP authorization trail 30. A portion 40 of packet 19 is encrypted with an ESP header, while a portion 50 is encrypted with an ESP authorization trailer.

In an embodiment, because load balancer 150 processes an L3 packet, load balancer 150 may not have access to L2 headers. However, to allow load balancer 150 to access the contents of inner 26-27 fields of the packet, an L2 enabled device may extract the contents of fields 26-27 before the packet is encapsulated, store the contents in a packet handle and allow load balancer 150 to access the contents using the packet handle to compute the hash value.

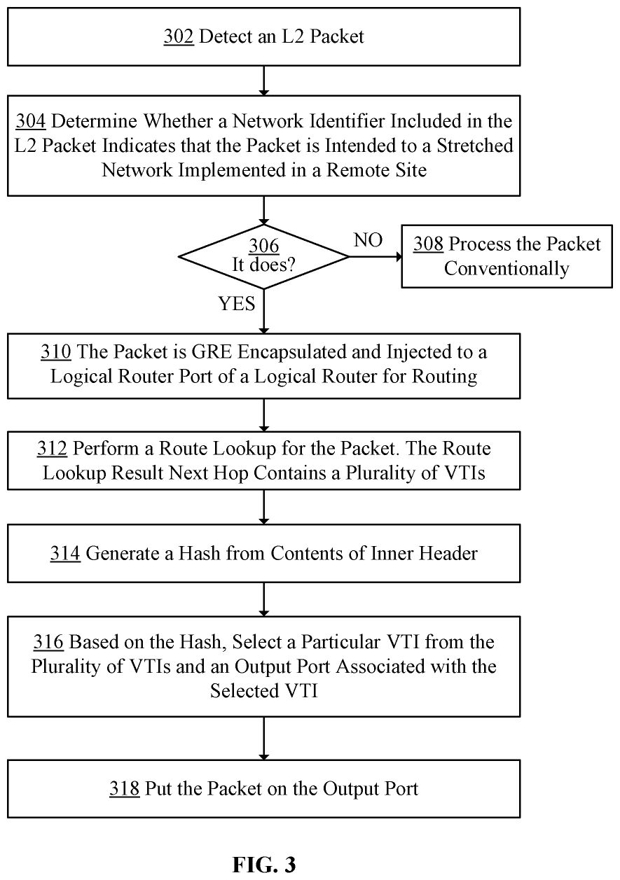

FIG. 3 is a flow chart for selecting, by a packet sending gateway, a virtual tunnel interface and selecting an IPsec VPN tunnel. The steps described in FIG. 3 pertain to implementing the load balancing mechanisms for L2VPN traffic on a packet sending side. A packet sending side may be gateway 110. Upon detecting a packet, gateway 110 computes a hash for the packet, selects either VTI 31 or VTI 33 based on the hash, and relays the packet onto either VPN tunnel 44 or VPN tunnel 54. By corollary, a packet sending side may be gateway 110A if gateway 110A detects a packet that needs to be communicated to gateway 110 via either VPN tunnel 44 or VPN tunnel 54.

Suppose that gateway 110 is implemented on a packet sending side. In step 302, gateway 110 detects an L2VPN packet. The packet may be sent by any of VMs 21-201 and may be intended to, for example, any of VMs 21A-201A.

In step 304, gateway 110 determines whether a VLAN ID or VNI ID included in the L2 packet indicates that the packet is intended to a stretched network implemented in a remote site, such as cloud 12. The network identifier identifies the network. If, in step 306, gateway 110 finds in the packet a unique network identifier identifying the remote site, then gateway 110 saves the contents of field 26 or both fields 26-27 and proceeds to step 310. Otherwise, gateway 110 processes the packet in step 308 conventionally, i.e., without incorporating the load balancing mechanisms presented herein.

In step 310, gateway 110 puts the packet to a logical router port of a logical router for routing. For example, gateway 110 may put the packet on a port of logical router 140.

In step 312, gateway 110 performs a route lookup for the packet. The route lookup result next hop contains a plurality of VTIs. Referring to FIG. 1, suppose that the plurality of VTIs includes VTI 31 and VTI 33.

In step 314, load balancer 150, or an ECMP process executed by logical router 140, determines whether the packet needs to be relayed onto VTI 31 or VTI 33. Logical router 140 makes that determination based on a hash value computed from contents of inner headers 26-27 that have been already saved and accessible via a packet handle.

In step 316, based on the computer hash value, logical router 140 selects either VTI 31 or VTI 33, and relays the packet onto the selected VTI. If the packet is relayed onto VTI 31, then the packet is encapsulated at least with the VPN address 42, put, in step 318, on an output port associated with VTI 31, and then communicated via IPsec VPN tunnel 44. However, if the packet is relayed onto VTI 33, then the packet is encapsulated at least with the VPN address 52, put, in step 318, on an output port associated with VTI 33, and then communicated via IPsec VPN tunnel 54. This completes the process of selecting the particular VTI and the particular VPN tunnel to communicate the packet from gateway 110 to gateway 110A.

Now suppose that gateway 110A is implemented on a packet sending side. In this situation, upon receiving an L2VPN packet from a VM, logical router 140A, or an ECMP process executed by logical router 140A, determines whether the packet needs to be relayed onto VTI 31A or VTI 33A. Logical router 140A makes that determination based on a hash value computed from contents of the inner header(s) included in the packet. Based on the hash value, logical router 140A selects either VTI 31A or VTI 33A and relays the packet onto the selected VTI. If the packet is relayed onto VTI 31A, then the packet is encapsulated at least with the VPN address 42A, and then communicated via IPsec VPN tunnel 44 to gateway 110. However, if the packet is relayed onto VTI 33A, then the packet is encapsulated at least with the VPN address 52A, and then communicated via IPsec VPN tunnel 54 to gateway 110A.

To implement the present approach, an L2VPN API is extended to provide the capabilities for establishing multiple VPN sessions for L2VPN session configurations created for edge gateways. Furthermore, device routes are extended to allow configuring multiple VTI interfaces for L2VPN traffic. For GRE traffic, a datapath process calculates hash values for GRE packets from contents of GRE headers, and uses a special code to allow the ECMP process to indicate the GRE traffic. For L2VPN traffic, the datapath process calculates hash values for the L2VPN traffic from the contents of inner IP and/or TCP/UDP headers of the packets and uses another special code to indicate the L2VPN traffic. The datapath process also uses the L2VPN status function to indicate whether at least one VTI device implemented on the gateway is up and operational and to indicate whether a route to the VTI device exists. If one of a plurality of VPN tunnels fails but at least one other VPN tunnel remains operational, then the L2VPN traffic fails over from the failed VPN tunnel onto the operational VPN tunnel.

2.2. Selecting a CPU Stack

The RSS functionalities may be implemented in a NIC and may provide mechanisms that allow a network driver to spread incoming traffic across multiple CPUs to increase the multi-core efficiency and to optimize the processor cache utilization. On a packet receiving side, the RSS may be used to select a CPU stack, from a plurality of CPUs implemented on the packet receiving side, that may be used to process the packet. The CPU is selected to allow balancing the usage of the CPU resources on the packet receiving side.

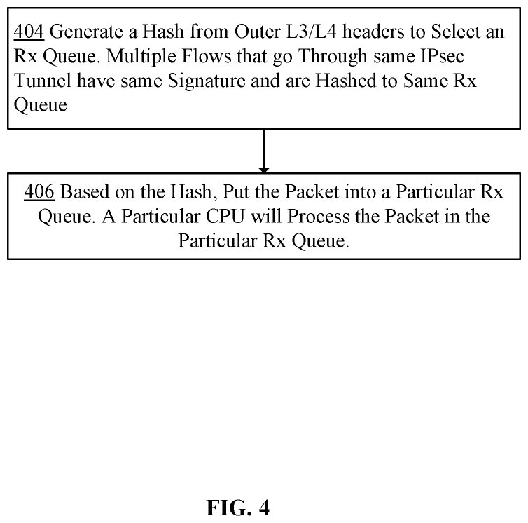

FIG. 4 is an example flow chart for selecting, by a packet receiving gateway, a CPU for processing an L2VPN packet. The steps described in FIG. 4 pertain to implementing the load balancing mechanisms for L2VPN traffic on a packet receiving side. A packet receiving side may be gateway 110A if gateway 110A detects a packet transmitted from gateway 110 via a VPN tunnel (either VPN tunnel 44 or VPN tunnel 54). By corollary, a packet receiving side may be gateway 110 if gateway 110 detects a packet transmitted from gateway 110A via a VPN tunnel (either VPN tunnel 44 or VPN tunnel 54). To provide a clear description, the steps described in FIG. 4 pertain to the first situations, i.e., when a packet receiving side is gateway 110A.

Suppose that gateway 110A is implemented on a packet receiving side. In step 404, upon detecting a packet on VTI 31A (or VTI 33A), a NIC (not shown) implemented in gateway 110A tries to identify an L4 header in the packet. The NIC also tries to identify an L3 header in the packet. If the NIC finds both L4-L3 headers, then the NIC invokes the RSS function to determine a hash value based on the contents of L4-L3 headers. If the NIC is unable to identify the L4 header in the packet, but the NIC can identify the L3 header in the packet, then the RSS function is invoked to determine a hash value based on the contents of L3 header. An example of an L3 header is an IP header 20 shown in FIG. 2B. The hash value is used to select an Rx queue.

In step 406, based on the hash, the packet is put into a particular Rx queue, and a particular CPU will process the packet in the particular Rx queue. Selecting a particular CPU stack allows a network driver to spread incoming traffic across multiple CPUs and thus increase the multi-core efficiency and processor cache utilization.

3. Improvements Provided by Certain Embodiments

In an embodiment, an approach presented herein provides mechanisms for load-balancing L2VPN traffic over multiple IPsec VPN tunnels between datacenters. The approach allows increasing throughput of the L2VPN traffic by distributing the traffic among a plurality of IPSec VPN tunnels established between the datacenters.

In an embodiment, an approach provides redundancy between IPsec VPN tunnels established between datacenters. Hence, if one of the multiple VPN tunnels fails, another VPN tunnel can take over.

In an embodiment, an approach allows more efficient processing of L2VPN packets than the conventional processing of the packets. It allows more efficient computations of hash values for the packets and more efficient selection of VTI devices based on the hashes.

In an embodiment, an approach allows balancing the CPU usage by a packet receiving side by allowing selecting a CPU stack from a plurality of CPU stacks based on hashes computed from L3/L4 headers.

4. Implementation Mechanisms

The present approach may be implemented using a computing system comprising one or more processors and memory. The one or more processors and memory may be provided by one or more hardware machines. A hardware machine includes a communications bus or other communication mechanisms for addressing main memory and for transferring data between and among the various components of hardware machine. The hardware machine also includes one or more processors coupled with the bus for processing information. The processor may be a microprocessor, a system on a chip (SoC), or other type of hardware processor.

Main memory may be a random-access memory (RAM) or other dynamic storage device. It may be coupled to a communications bus and used for storing information and software instructions to be executed by a processor. Main memory may also be used for storing temporary variables or other intermediate information during execution of software instructions to be executed by one or more processors.

5. General Considerations

Although some of various drawings may illustrate a number of logical stages in a particular order, stages that are not order dependent may be reordered and other stages may be combined or broken out. While some reordering or other groupings may be specifically mentioned, others will be obvious to those of ordinary skill in the art, so the ordering and groupings presented herein are not an exhaustive list of alternatives. Moreover, it should be recognized that the stages could be implemented in hardware, firmware, software or any combination thereof.

The foregoing description, for purpose of explanation, has been described regarding specific embodiments. However, the illustrative embodiments above are not intended to be exhaustive or to limit the scope of the claims to the precise forms disclosed. Many modifications and variations are possible in view of the above teachings. The embodiments were chosen to best explain the principles underlying the claims and their practical applications, to thereby enable others skilled in the art to best use the embodiments with various modifications as are suited to the uses contemplated.

Any definitions set forth herein for terms contained in the claims may govern the meaning of such terms as used in the claims. No limitation, element, property, feature, advantage or attribute that is not expressly recited in a claim should limit the scope of the claim in any way. The specification and drawings are to be regarded in an illustrative rather than a restrictive sense.

What is claimed is:

1. A computer-implemented method for load balancing of L2VPN traffic over multiple IPsec VPN tunnels, the method comprising:
performing, by a gateway, a lookup of available virtual tunnel interfaces (“VTIs”) implemented in the gateway to determine a plurality of VTIs;
generating a hash value from contents of one or more inner headers of a packet;
based on the hash value, determining a VTI device identifier;
wherein the VTI device identifier uniquely identifies a particular VTI from the plurality of VTIs; and
relaying the packet on a gateway output port that is associated with the particular VTI to allow forwarding of the packet via a particular IPsec VPN tunnel of a plurality of IPsec VPN tunnels.

2. The computer-implemented method of claim 1, wherein the hash value for the packet is determined based on contents of one or more of: an inner IP header of the packet or an inner TCP/UDP header of the packet;
wherein the hash value for the packet is determined based on a 5-tuple included in the one or more inner headers;
wherein the hash value for the packet is determined by applying an XOR operator to elements of the 5-tuple; and
wherein the hash value is used as an index in a lookup table to determine the particular VTI; and
wherein the lookup table comprises mappings between hash values and VTI device identifiers.

3. The computer-implemented method of claim 1, wherein the hash value for the packet is determined based on contents of an inner VLAN header of the packet.

4. The computer-implemented method of claim 1, wherein an IPsec VPN tunnel of the plurality of IPsec VPN tunnels is associated with a corresponding VPN session and is defined at least by two endpoints, each of the endpoints having a unique underlay VPN address; and
wherein a VTI of the plurality of VTIs has an associated VTI address which is uniquely mapped onto one of two VPN addresses of an IPsec VPN tunnel of the plurality of IPsec VPN tunnels.

5. The computer-implemented method of claim 1, further comprising:
before relaying the packet on the gateway output port associated with the particular VTI:
extracting from the packet the contents of the one or more inner headers;
storing the contents of the one or more inner headers in a memory buffer to be used to compute the hash value;
determining one or more outer headers for the packet; and
encapsulating the packet with the one or more outer headers.

6. The computer-implemented method of claim 1, further comprising:
detecting the packet;
parsing the packet to determine whether a network identifier included in the packet indicates that the packet is intended to a stretched network implemented in a remote site; and
in response to determining that the network identifier included in the packet indicates that the packet is intended to the stretched network implemented in the remote site,
relaying the packet on a logical router port of a logical router communicatively coupled to the gateway and indicating that the packet is to be communicated via the particular IPsec VPN tunnel of the plurality of IPsec VPN tunnels to the remote site.

7. The computer-implemented method of claim 6, further comprising:
in response to determining that the network identifier included in the packet indicates that the packet is not intended to the stretched network implemented in the remote site,
relaying the packet on the logical router port of the logical router communicatively coupled to the gateway and indicating that the packet is to be conventionally communicated via an IPsec VPN tunnel to the remote site.

8. One or more non-transitory computer-readable storage media storing one or more computer instructions which, when executed by one or more processors, cause the one or more processors to perform:
performing, by a gateway, a lookup of available virtual tunnel interfaces (“VTIs”) implemented in the gateway to determine a plurality of VTIs;
generating a hash value from contents of one or more inner headers of a packet;
based on the hash value, determining a VTI device identifier;
wherein the VTI device identifier uniquely identifies a particular VTI from the plurality of VTIs; and
relaying the packet on a gateway output port that is associated with the particular VTI to allow forwarding of the packet via a particular IPsec VPN tunnel of a plurality of IPsec VPN tunnels.

9. The one or more non-transitory computer-readable storage media of claim 8, wherein the hash value for the packet is determined based on contents of one or more of: an inner IP header of the packet or an inner TCP/UDP header of the packet;
wherein the hash value for the packet is determined based on a 5-tuple included in the one or more inner headers;
wherein the hash value for the packet is determined by applying an XOR operator to elements of the 5-tuple; and
wherein the hash value is used as an index in a lookup table to determine the particular VTI; and
wherein the lookup table comprises mappings between hash values and VTI device identifiers.

10. The one or more non-transitory computer-readable storage media of claim 8, wherein the hash value for the packet is determined based on contents of an inner VLAN header of the packet.

11. The one or more non-transitory computer-readable storage media of claim 8, wherein an IPsec VPN tunnel of the plurality of IPsec VPN tunnels is associated with a corresponding VPN session and is defined at least by two endpoints, each of the endpoints having a unique underlay VPN address; and
wherein a VTI of the plurality of VTIs has an associated VTI address which is uniquely mapped onto one of two VPN addresses of an IPsec VPN tunnel of the plurality of IPsec VPN tunnels.

12. The one or more non-transitory computer-readable storage media of claim 8, storing additional instructions which, when executed by the one or more processors cause the one or more processors to perform:
before relaying the packet on the gateway output port associated with the particular VTI:
extracting from the packet the contents of the one or more inner headers;
storing the contents of the one or more inner headers in a memory buffer to be used to compute the hash value;
determining one or more outer headers for the packet; and
encapsulating the packet with the one or more outer headers.

13. The one or more non-transitory computer-readable storage media of claim 8, storing additional instructions which, when executed by the one or more processors cause the one or more processors to perform:
detecting the packet;
parsing the packet to determine whether a network identifier included in the packet indicates that the packet is intended to a stretched network implemented in a remote site; and
in response to determining that the network identifier included in the packet indicates that the packet is intended to the stretched network implemented in the remote site,
relaying the packet on a logical router port of a logical router communicatively coupled to the gateway and indicating that the packet is to be communicated via the particular IPsec VPN tunnel of the plurality of IPsec VPN tunnels to the remote site.

14. The one or more non-transitory computer-readable storage media of claim 13, storing additional instructions which, when executed by the one or more processors cause the one or more processors to perform:
in response to determining that the network identifier included in the packet indicates that the packet is not intended to the stretched network implemented in the remote site,
relaying the packet on the logical router port of the logical router communicatively coupled to the gateway and indicating that the packet is to be conventionally communicated via an IPsec VPN tunnel to the remote site.

15. An edge service gateway implemented in a computer network and configured to implement mechanisms for load balancing of L2VPN traffic over multiple IPsec VPN tunnels, the edge service gateway comprising:
one or more processors;
one or more memory units; and
one or more non-transitory computer-readable storage media storing one or more computer instructions which, when executed by the one or more processors, cause the one or more processors to perform:
performing, by a gateway, a lookup of available virtual tunnel interfaces (“VTIs”) implemented in the gateway to determine a plurality of VTIs;
generating a hash value from contents of one or more inner headers of a packet;
based on the hash value, determining a VTI device identifier;
wherein the VTI device identifier uniquely identifies a particular VTI from the plurality of VTIs; and
relaying the packet on a gateway output port that is associated with the particular VTI to allow forwarding of the packet via a particular IPsec VPN tunnel of a plurality of IPsec VPN tunnels.

16. The edge service gateway of claim 15, wherein the hash value for the packet is determined based on contents of one or more of: an inner IP header of the packet or an inner TCP/UDP header of the packet;
wherein the hash value for the packet is determined based on a 5-tuple included in the one or more inner headers;
wherein the hash value for the packet is determined by applying an XOR operator to elements of the 5-tuple; and
wherein the hash value is used as an index in a lookup table to determine the particular VTI; and
wherein the lookup table comprises mappings between hash values and VTI device identifiers.

17. The edge service gateway of claim 15, wherein the hash value for the packet is determined based on contents of an inner VLAN header of the packet.

18. The edge service gateway of claim 15, wherein an IPsec VPN tunnel of the plurality of IPsec VPN tunnels is associated with a corresponding VPN session and is defined at least by two endpoints, each of the endpoints having a unique underlay VPN address; and
wherein a VTI of the plurality of VTIs has an associated VTI address which is uniquely mapped onto one of two VPN addresses of an IPsec VPN tunnel of the plurality of IPsec VPN tunnels.

19. The edge service gateway of claim 15, storing additional instructions which, when executed by the one or more processers, cause the one or more processors to perform:
before relaying the packet on the gateway output port associated with the particular VTI:
extracting from the packet the contents of the one or more inner headers;
storing the contents of the one or more inner headers in a memory buffer to be used to compute the hash value;
determining one or more outer headers for the packet; and
encapsulating the packet with the one or more outer headers.

20. The edge service gateway of claim 15, storing additional instructions which, when executed by the one or more processers, cause the one or more processors to perform:
detecting the packet;
parsing the packet to determine whether a network identifier included in the packet indicates that the packet is intended to a stretched network implemented in a remote site; and
in response to determining that the network identifier included in the packet indicates that the packet is intended to the stretched network implemented in the remote site,
relaying the packet on a logical router port of a logical router communicatively coupled to the gateway and indicating that the packet is to be communicated via the particular IPsec VPN tunnel of the plurality of IPsec VPN tunnels to the remote site.
